(19) United States
(12) Patent Application Publication
(10) Pub. No.: US 2007/0242908 A1
(43) Pub. Date: Oct. 18, 2007

(54) Forming Method of Dynamic Pressure Generating Portion and Fluid Dynamic Bearing Device

(76) Inventors: Tatsuo Nakajima, Iwata-shi (JP); Ryouichi Nakajima, Kuwana-shi (JP); Isao Komori, Kuwana-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/592,429

(22) PCT Filed: Apr. 12, 2005
(86) PCT No.: PCT/JP05/07092

§ 371 Date: May 18, 2007

(30) Foreign Application Priority Data
Apr. 20, 2004 (JP) 2004-124645
Sep. 27, 2004 (JP) 2004-279903
Oct. 7, 2004 (JP) 2004-295263
Jan. 21, 2005 (JP) 2005-014598
Jan. 27, 2005 (JP) 2005-020077

(51) Int. Cl. F16C 32/06

(52) U.S. Cl. 384/112; 310/46; 384/100; 384/107

(57) ABSTRACT

The present invention aims to make it possible to form a dynamic pressure generating portion by a simple process with high accuracy at a low cost. In order to achieve the object, in the present invention the dynamic pressure generating portion A is formed by the step of supplying a small amount of an ink 12 onto a surface of a material 2a′ to print the dynamic pressure generating portion A for generating a dynamic pressure of fluid in a bearing gap with an aggregate of the ink, and the step of hardening the ink 12.

### TECHNICAL FIELD

The present invention relates to a method for forming a dynamic pressure generating portion on a material, and also relates to a fluid dynamic bearing device including this dynamic pressure generating portion.

### BACKGROUND ART

A dynamic bearing generates a pressure by using a dynamic pressure action of fluid caused by relative rotation of a shaft member and a bearing sleeve in a bearing gap, and supports the shaft member in a non-contact manner by the thus generated pressure. The dynamic bearing has features of high-speed rotation, high rotational accuracy, low noise, and the like. In recent years, by bringing the features into play, applications of the dynamic bearing have expanded. For example, the dynamic bearing can be used as a bearing for a spindle motor used in information equipment, e.g., a magnetic disc device such as HDD or FDD, an optical disc device such as CD-ROM, CD-R/RW, or DVD-ROM/RAM, and a magnetooptical device such as MD or MO, a bearing for a polygon scanner motor of a laser beam printer (LBP), a bearing for a color wheel of a projector, or a bearing for a small motor in electric equipment such as an axial fan.

In the dynamic bearing, grooves for generating a dynamic pressure (dynamic pressure generating grooves) that are arranged in a herringbone pattern, a spiral pattern, or the like are formed as a dynamic pressure generating portion on an outer circumferential surface of a shaft member, for example. The following methods (1) to (3) are known as a method for forming such a special and complicated pattern of the dynamic pressure generating grooves with high accuracy.

(1) Portions of the groove pattern other than the dynamic pressure generating grooves are printed with a corrosion-resistant ink on the outer circumference of the shaft member in combination with electrochemical methods. Then, non-printed portions are caused to corrode by etching, thereby forming the dynamic pressure generating grooves.

(2) The shaft member is rotated by 360 degrees, while being in contact with a printing mold of a printing device. In this manner, the portions other than the dynamic pressure generating grooves are printed with a corrosion-resistant ink on the outer circumference of the shaft member. Then, etching is performed for the shaft member so as to form the dynamic pressure generating grooves.

(3) The printing mold is moved with rotation of the shaft member, while being in contact with the outer circumferential surface of the shaft member. In this manner, the portions other than the dynamic pressure generating grooves are printed with a corrosion-resistant ink (UV-curing ink) on the outer circumference of the shaft member. The ink is cured by irradiating portions other than a portion that is in contact with the shaft-like printing mold with ultraviolet rays (see Patent Publication 1).

[Patent Document 1]

Japanese Patent Laid-Open Publication No. 1982-35682

However, in the method (1), the process is too complicated to perform rationalization. In the method (2), while the shaft member is rotated by 360 degrees, overlapping of ink that is not sufficiently hardened occurs at a junction of the printed portions. This easily causes deterioration of the groove pattern. Therefore, correction of the groove pattern should be performed after the printing.

In the method (3), the printing mold is moved while being in contact with the outer circumferential surface of the shaft member. Thus, wear can easily occur at the contact portion. Therefore, there is concern that the printing accuracy is lowered because of the wear, deformation, and the like of the printing mold in case of mass production. Moreover, the printing mold is required to correspond to the pattern of the dynamic pressure generating grooves and a shape of a material such as the shape of the shaft member. Thus, it is difficult to deal with a wide variety of demands in recent years. In addition, the corrosion-resistant ink supplied from an ink supply device reaches the outer circumferential surface of the shaft member via the printing mold, and is then pressed and fixed onto the outer circumferential surface by means of a squeegee. Therefore, extra corrosion-resistant ink that is not involved in the formation of the grooves is required. This increases the used amount of the corrosion-resistant ink that is expensive and therefore the method (3) is not economical.

Furthermore, after the printing, corrosion of the unprinted portion by etching and removal of the ink are essential. Therefore, the forming process is complicated and contains multiple steps, thus increasing the cost.

The dynamic pressure generating grooves may be formed by machining (e.g. cutting work or plastic forming). However, in case of machining, it is difficult to form the dynamic pressure generating grooves with high accuracy. Moreover, this method is not economical. On the other hand, the dynamic bearing may be operated with high-velocity revolution, such as several tens of thousands of revolutions per minute. Therefore, it is necessary to ensure the sufficient durability even when the dynamic bearing rotates with such high-velocity revolution.

In case of curing the ink by radiation of ultraviolet rays, as described above, the curing of the ink begins at a part that is irradiated with ultraviolet rays first, i.e., an outer part of the ink. The curing at an adhering interface takes place later. Thus, before a curing action by ultraviolet rays takes place around the interface between the ink and the shaft member, an adhesive state at that interface is unstable. Therefore, under a certain printing condition or for some specifications of a bearing device, the ink may peel off or fall during the printing or a later process. The separation or falling of the ink deteriorates the accuracy of the dynamic pressure generating portion and lowers the rotational accuracy of the fluid dynamic bearing device.

It is therefore an object of the present invention to enable formation of a dynamic pressure generating portion by a simple process with high accuracy at a low cost.

It is another object of the present invention to reduce the cost of a fluid dynamic bearing device and ensure its durability.

It is still another object of the present invention to accelerate hardening of the dynamic pressure generating portion that is printed.

### DISCLOSURE OF THE INVENTION

As means for achieving those objects, the present invention includes the steps of: supplying a small amount of an ink onto a surface of a material to print a dynamic pressure generating portion for generating a dynamic pressure of fluid in a bearing gap with an aggregate of the small amount of ink; and hardening the ink.

The “dynamic pressure generating portion” described here can has any form, as long as it can generate a pressure due to a dynamic pressure action of the fluid in the bearing gap. For example, the “dynamic pressure generating portion” may be formed by a plurality of grooves (e.g., grooves extending in an axial direction or tilted grooves such as spiral grooves or herringbone grooves) and convex backs that are arranged between those grooves for sectioning and forming those grooves, or may be formed by a plurality of circular-arc surfaces that make the bearing gap smaller toward at least one of circumferential directions. Moreover, the “dynamic pressure generating portion” can be formed on an outer circumferential surface or an end face of a shaft member, or on an inner circumferential surface or an end face of a sleeve-like member (e.g., a bearing sleeve), for example. A surface or ace on which the “dynamic pressure generating portion” is printed can be curved or flat. The material of the dynamic pressure generating portion is not specifically limited. Any of metallic materials (e.g., steels such as stainless steel, soft metals such as brass, and sintered metal) and resin compositions is selected in accordance with required bearing properties in an appropriate manner.

As a method for supplying the small amount of ink onto the surface of the material during formation of the dynamic pressure generating portion, a so-called ink-jet method can be used, for example. In this method, small droplets of the ink are discharged from a nozzle to reach the surface of the material. Other than the above method, a nozzle-less type ink-jet method in which no nozzle is used and the droplets of ink are caused to jump from a surface of the ink, a method in which the ink is directed by electrophoresis, a method in which the ink is not discharged in the form of droplets but is continuously discharged through a micropipette, or a method in which a distance to a surface where the ink is fixed is shortened and the ink is made to land on that fixing surface simultaneously with the discharge of the ink, can also be used.

The aforementioned exemplary method for supplying the small amount of ink can precisely control the amount and the position of the supplied ink. Thus, by programming a shape pattern of the dynamic pressure generating portion in advance and controlling a position of an ink supply portion (e.g., nozzle), the amount of the supplied ink, and supply and stop timings of the ink in accordance with the program, it is possible to print a given and highly-accurate shape pattern with the aggregate of the small droplets of the ink. In addition, each portion of the shape pattern can be formed with a given thickness.

Moreover, the aforementioned exemplary ink supply method enables printing, while the ink supply portion and the surface of the material are not in contact with each other. Thus, not only printing with high accuracy can be performed, but also deterioration of the accuracy caused by wear in a contact portion that may occur in a conventional technique can be avoided. In addition, it is not necessary to supply extra ink to a printing mold and then remove the extra ink by means of a squeegee. That is, the ink is used only at a position that requires the ink in the present invention. Therefore, the required amount of the ink is only the amount for forming the dynamic pressure generating portion. That is, the used amount of ink can be reduced. Furthermore, the aforementioned exemplary ink supply method does not require a printing mold and a mechanism for moving the printing mold with rotation of the shaft member. Therefore, a forming device can be simplified.

According to the method described above, the dynamic pressure generating portion can be formed by the hardened ink (resin composition). In this case, the dynamic pressure generating portion formed by the ink can be incorporated into a fluid dynamic bearing device and be used as a bearing surface, without being subjected to a corrosion process which performs etching or the like, a process for removing the corrosion-resistant ink after the etching, and the like. Therefore, a forming process of the dynamic pressure generating portion can be largely simplified.

In this case, when a printing portion for printing the dynamic pressure generating portion and a hardening portion for hardening the ink are provided at different positions in a circumferential direction and the material, the printing portion, and the hardening portion are relatively rotated to make the printing of the dynamic pressure generating portion and the hardening of the ink proceed in the circumferential direction of the material, the printing of the dynamic pressure generating portion on the surface of the material and the hardening of the ink can be made to occur in parallel, thus reducing a cycle time. Moreover, the ink is completely hardened when a portion on the surface of the material, at which the printing begins, goes around the material. Therefore, it is possible to prevent deterioration of the printing accuracy caused by overlapping of the ink that is not sufficiently hardened.

In addition, the material has a blocking function with respect to an ink-hardening action (e.g., radiation of ultraviolet rays in case of using UV-curing ink) of the hardening portion. Thus, it is possible to prevent the ink-hardening action from affecting the printing portion and impairing the workability of the printing. From that viewpoint, it is desirable that the printing portion and the hardening portion be arranged at positions opposed to each other with an axial center of the material interposed therebetween.

The ink can be hardened by radiation of electromagnetic rays such as electron beams or light beams. It is desirable to use a photocrosslinking ink and cure it by radiation of light, when the cost, working conditions, and the like are considered. As the photocrosslinking ink, an ink that is curable by radiation of ultraviolet rays or infrared rays, or an ink that is curable by radiation of visible light can be used. Especially, a UV-curing ink that can be cured at a low cost in a short period of time is desirable.

The aforementioned dynamic pressure generating portion can be formed by a forming device that includes: an ink supply portion for intermittently supplying a small amount of an ink on a surface of a material; and a light source for emitting light for hardening the ink. In the forming device, the ink supply portion and the light source are arranged to be opposed to the material at different positions in a circumferential direction, and the material, the ink supply portion, and the light source are relatively rotated.

According to the forming method and the forming device described above, a shaft member having a dynamic pressure generating portion, for example, on its outer circumferential surface can be manufactured at a low cost. A fluid dynamic bearing device can be formed by this shaft member and a bearing sleeve into which the shaft member is inserted. In this case, an inner circumferential surface of the bearing sleeve can be a smooth cylindrical surface on which no dynamic pressure generating portion is formed.

A bearing sleeve having a dynamic pressure generating portion on its inner circumferential surface can be manufactured by a method and a device that are similar to the above. A fluid dynamic bearing device can be formed by this bearing sleeve and a shaft member that is inserted into the bearing sleeve. In this case, an outer circumferential surface of the shaft member can be a smooth cylindrical surface on which no dynamic pressure generating portion is formed.

Alternatively, a fluid dynamic bearing device can be composed of a shaft member having a dynamic pressure generating portion that is formed by the forming method and the forming device described above on its outer circumferential surface, and a bearing sleeve having a dynamic pressure generating portion that is formed by the similar forming method and the similar forming device on its inner circumferential surface.

In the case where etching is performed for forming the dynamic pressure generating portion as in a conventional technique, the ink forming the dynamic pressure generating portion is completely removed after the etching and therefore no ink remains on the surface of the material. On the other hand, in the case where the dynamic pressure generating portion is formed by the ink as in the present invention, the ink as resin composition is not removed but remains on the surface of the shaft member or the bearing sleeve. In this case, contact of the shaft member with the bearing sleeve when the bearing is started to operate, stopped, and the like is achieved through the resin composition. That is, the material of the member having the dynamic pressure generating portion thereon (i.e., the shaft member or the bearing sleeve) does not come onto contact with the opposed member. Therefore, importance of the abrasion resistance is lowered among the properties required for that material, thus improving freedom of selecting the material therefor. Moreover, it is unnecessary to perform a heat treatment for improving the abrasion resistance. Therefore, the shaft member or the bearing sleeve can be formed from a metallic material that is not subjected to a heat treatment.

A fluid dynamic bearing device of the present invention includes: a housing; a bearing sleeve fixed on an inner circumference of the housing; a shaft member inserted in the bearing sleeve; a radial bearing portion for supporting the shaft member in a radial direction in a non-contact manner; a thrust bearing portion for supporting the shaft member in a thrust direction; and a dynamic pressure generating portion, formed by hardening an aggregate of a small amount of an ink supplied onto a surface of a material of the shaft member, for generating a dynamic pressure of fluid in a bearing gap.

When the dynamic pressure generating portion formed by hardening the aggregate of the small amount of ink is formed on an outer circumferential surface of the shaft member, the radial bearing portion is constituted by a dynamic bearing. In this case, the shaft member is supported in the radial direction in a non-contact manner by a dynamic pressure action of lubricating fluid generated in a radial bearing gap between the outer circumferential surface of the shaft member and an inner circumferential surface of the bearing sleeve.

When this dynamic pressure generating portion is formed on an end face of the shaft member or a surface opposed to that end face, the thrust bearing portion is constituted by a dynamic bearing. In this case, the shaft member can be supported in the thrust direction in a non-contact manner by a dynamic pressure action of lubricating fluid generated in a thrust bearing gap.

The aforementioned dynamic pressure generating portion formed by the aggregate of the small amount of ink can be provided in each of the radial bearing portion and the thrust bearing portion or in one of them.

In case of using an oil as the lubricating fluid of the fluid dynamic bearing device, the oil is always in contact with a surface of the dynamic pressure generating portion. In this case, when the dynamic pressure generating portion is formed from a resin composition obtained by hardening the ink as described above, compatibility of the resin composition and the oil with respect to each other (i.e., oil resistance of the resin composition) becomes an important issue. In the case where the dynamic pressure generating portion is formed from a metal, for example, the metal has oil resistance and therefore the use of metal has no problem. On the other hand, in the case where the dynamic pressure generating portion is formed from a resin composition, the type of the resin composition should be selected in careful consideration of the oil resistance with respect to the oil to be used. If a resin composition that has low oil resistance is used, an oil with which the inside of the bearing device is filled enters the inside of the resin composition from the surface thereof, causing swelling of the resin composition. This may lower an elastic modulus of the dynamic pressure generating portion formed of the resin composition, which may in turn cause troubles such as wear of the dynamic pressure generating portion. Alternatively, penetration of the lubricating oil to the inside of the resin composition lowers an adhesive force at an interface between the resin composition and the material (e.g., the shaft member or the bearing sleeve), thus causing separation of the resin composition from the material.

Therefore, according to the present invention, in a fluid dynamic bearing device including: a shaft member; a bearing gap facing the shaft member; an oil with which the bearing gap is filled; and a dynamic pressure generating portion for generating a dynamic action of the oil in the bearing gap, the dynamic pressure generating portion is formed from a resin composition and a solubility parameter of a base resin contained in the resin composition and a solubility parameter of the oil are set in such a manner that an absolute value of a difference between them is 1.0 or more.

The solubility parameter is an index indicating an electric polarity of a material. Materials that are close in the solubility parameter are more soluble with respect to each other, whereas materials that are distant in the solubility parameter are less soluble with respect to each other. In the present invention, a value of the solubility parameter (hereinafter, referred to as an SP value) δ is calculated based on an expression given by R. F. Fedors as follows.
δ=(ΣΔₑᵢ/Σ+66ᵥᵢ)^{1/2} (unit: (cal/cm³)^{1/2}≈2.05×(J/cm³)^{1/2}=2.05×(MJ/m³)^{1/2})
where

Δₑᵢ: Evaporation energy of an atom or atoms (unit: (cal/mol)≈4.186×(J/mol))

Δᵥᵢ: Molar volume of an atom or atoms (unit: (cm³/mol)=10⁻⁶×(m³/mol))

As the unit of the SP value, (cal/cm³)^{1/2} is used in accordance with a common usage.

When the dynamic pressure generating portion is formed from the resin composition containing the base resin that has the SP value having an absolute difference of 1.0 or more from the solubility parameter of the oil as in the present invention, it is possible to prevent the oil from entering from the surface of the dynamic pressure generating portion formed from that resin composition into the inside thereof. Thus, lowering of the elastic modulus caused by the swelling of the dynamic pressure generating portion can be avoided and wear of the dynamic pressure generating portion caused by contact with a member opposed to the dynamic pressure generating portion can also be prevented. Moreover, it is possible to prevent the dynamic pressure generating portion formed of a resin from peeling off from the material onto which the dynamic pressure generating portion is to be fixed (i.e., the shaft member, the bearing member, or the like). Please note that the absolute difference of the solubility parameter between the oil and the resin composition of 1.0 is a boundary value for distinguishing a state where the resin composition (especially, the base resin) and the oil are soluble with respect to each other from a state where they are not soluble. In other words, as the absolute difference becomes smaller from 1.0, the amount of swelling of the resin composition caused by the oil increases. On the other hand, when the absolute difference becomes 1.0 or more, the swelling of the resin composition caused by the oil becomes very small, regardless of a value of the absolute difference. Thus, adverse effects of the swelling of the resin composition on the bearing performance can be prevented.

In this case, when the ink-jet method is employed as describe above, the resin composition of the dynamic pressure generating portion can be formed by hardening an aggregate of a small amount of an ink. As the base resin of the resin composition, any resin that can be hardened by application of various energies can be used. When the cost, working conditions, and the like are considered, it is preferable to use a photocrosslinking resin and cure it by radiation of light. As the photocrosslinking resin, a UV-curing resin, a resin that is curable by radiation of infrared rays, and a resin that is curable by radiation of visible light can be used. Especially, the UV-curing resin is preferable because it can be cured at a low cost in a short period of time. The used oil is preferably a diester lubricating oil. In case of using a mixture of a plurality of types of oils, a solubility parameter of oil obtained by the mixing or a solubility parameter of oil that can be regarded as a base oil or the mixture is used for determination whether or not the aforementioned condition is satisfied.

A resin composition of the present invention is a resin composition for forming a dynamic pressure generating portion for generating a dynamic pressure action of oil in a bearing gap, on a surface of a material, wherein an absolute value of a difference between a solubility parameter of a base resin of the resin composition and a solubility parameter of the oil is 1.0 or more.

An oil of the present invention comes into contact with a surface of a dynamic pressure generating portion that is formed on a surface of a material and generates a dynamic pressure action of the oil in a bearing gap. An absolute value of a difference between a solubility parameter of the oil and a solubility parameter of a base resin of a resin composition forming the dynamic pressure generating portion is 1.0 or more.

A fluid dynamic bearing device can also be used which includes a shaft member, a bearing gap facing the shaft member, and a dynamic pressure generating portion for generating a dynamic pressure action of fluid in the bearing gap, wherein the dynamic pressure generating portion is formed by hardening an aggregate of a small amount of a thermosetting ink. This means that the ink is thermally set when the dynamic pressure generating portion for generating the dynamic pressure action of the fluid in the bearing gap is formed by the aggregate of the small amount of ink on a surface of a material.

In this case, the ink can be directly set by radiation of heat or can be set by heating the material and using conduction of heat. The latter method (which heats the material to set the ink by conduction of heat) is more desirable in order to make the setting of the ink proceed from an adhering interface and ensure the good adhesion early.

When this configuration is employed, it is not necessary to provide a complicated hardening device such as an UV-radiation device in a process. Therefore, the manufacturing process can be simplified. The material can be heated while the printing is performed, or can be heated in advance before the material is subjected to the printing. In any case, according to the present invention, the hardening of the ink and the printing can be started simultaneously. Thus, it is possible to form the dynamic pressure generating portion having the high durability with high accuracy, while preventing the separation or falling of the ink. The heating of the material can be achieved by so-called internal heating or so-called external heating.

In addition to the thermosetting ink, an ink having both the thermosetting property and the photocrosslinking property can be used. In this case, the hardening of the ink makes progress from both the surface of the ink and the adhering interface due to a thermosetting action and a photocrosslinking action. Thus, a hardening rate can be largely increased and therefore a cycle time and the manufacturing cost can be reduced. In this case, it is necessary to further provide a light radiation device for photocrosslinking of the ink.

On the other hand, in case of curing the ink only by radiation of light, it is difficult to design a shape of a light guide and arrange a light radiation device in order to uniformly cure all droplets of the ink. However, according to the present invention, the radiation of light is used in order to accelerate the hardening of the ink, as described above. Thus, the accuracy of the radiation of light is not kept so precise, and therefore freedom of design selection of the light guide and the light radiation device can be improved.

In order to make the ink have both the thermosetting property and the photocrosslinking property, a thermosetting resin is used as a base resin, and a mixture of a thermosetting initiator and a photocrosslinking (polymerization) initiator or an initiator of thermosetting and photocrosslinking (polymerization) is added to the base resin, for example. As the photocrosslinking initiator, a UV-curing type, a type that can be cured by radiation of infra-red rays, and a type that can be cured by radiation of visible light can be used. The UV-curing type is especially desirable because it can be cured at a low cost in a short period of time.

A motor including the fluid dynamic bearing device having the aforementioned structure, a rotor magnet, and a stator coil can be preferably used as a spindle motor for the aforementioned information equipment, e.g., a magnetic disc drive such as a hard disc drive (HDD), for example.

As described above, according to the present invention, the process for etching the dynamic pressure generating portion and the process for removing the hardened ink can be omitted. Thus, the dynamic pressure generating portion can be formed at a low cost. Therefore, a fluid dynamic bearing device including the highly accurate dynamic pressure generating portion can be obtained at a low cost.

Moreover, according to the present invention, the dynamic pressure generating portion is formed from the resin composition that has excellent oil resistance. Thus, wear of the surface of the dynamic pressure generating portion can be suppressed. Therefore, the bearing performance can be kept stable over a long period of time and the durability thereof can be improved.

By forming the dynamic pressure generating portion from a thermosetting ink, the cycle time when the dynamic pressure generating portion is formed can be reduced, thereby reducing the cost. In addition, the dynamic pressure generating portion can be formed with high accuracy.

### BRIEF DESCRIPTION OF THE DRAWINGS

FIG. 1 is a cross-sectional view schematically showing an ink-jet type forming device.

FIGS. 2a and 2b are cross-sectional views schematically showing a fluid dynamic bearing device; FIG. 2a shows a case where a thrust bearing portion T is constituted by a pivot bearing; and FIG. 2b shows a case where thrust bearing portions T1 and T2 are constituted by dynamic bearings, respectively.

FIG. 3 is a side view showing another example of a printing process in the forming device.

FIG. 4 is an enlarged cross-sectional view of a surface of a material of a shaft member.

FIG. 5 is a cross-sectional view schematically showing an ink-jet forming device.

FIG. 6 is a cross-sectional view schematically showing an ink-jet forming device.

FIG. 7 is a cross-sectional view of an embodiment of the fluid dynamic bearing device according to the present invention.

FIG. 8 is a cross-sectional view of an embodiment of the fluid dynamic bearing device according to the present invention.

FIG. 9 is a cross-sectional view of an embodiment of the fluid dynamic bearing device according to the present invention.

FIG. 10 is a cross-sectional view of an embodiment of the fluid dynamic bearing device according to the present invention.

FIG. 11 is a cross-sectional view of a spindle motor incorporating the fluid dynamic bearing device therein.

### BEST MODE FOR CARRYING OUT THE INVENTION

Embodiments of the present invention are now described with reference to the drawings.

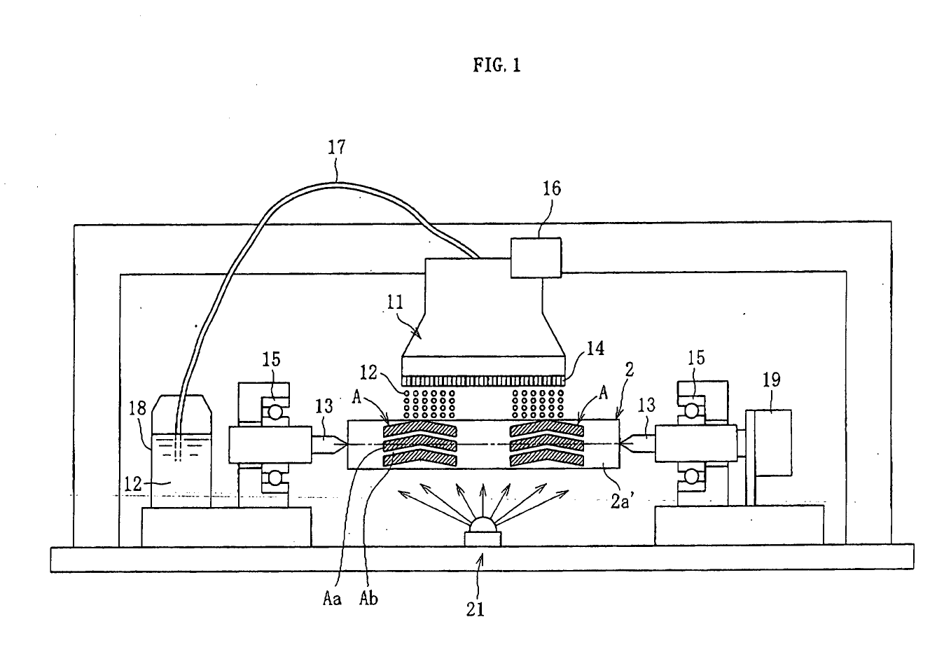

FIG. 1 generally shows an ink-jet type forming device as an exemplary forming device for forming a dynamic pressure generating portion according to the present invention. In this forming device, a material 2a′ of a shaft member 2 is supported transversely by shaft-like holding portions 13 that are pressed against the material 2a′ on respective sides. The two holding portions 13 are rotatably supported by roller bearings 15, respectively. One of the holding portions 13 is connected to a rotary drive portion 19 formed by a motor or the like. When the rotary drive portion 19 is actuated, the material 2a′ receives a rotary power through the holding portion 13 and rotates.

The material 2a′ is formed of metal such as stainless steel and is in a shaft shape. One or more nozzle heads 11 and a light source 21 are arranged around an outer circumference of the material 2a′. In the present embodiment, the nozzle head 11 serves as a printing portion for supplying an ink to the outer circumference of the material 2a′ and the light source 21 serves as a hardening portion for hardening the ink thus supplied. The nozzle head 11 and the light source 21 are arranged at different positions in a circumferential direction, respectively. It is preferable that the nozzle head 11 and the light source 21 be arranged at positions opposed to each other with the material 2a′ interposed therebetween, as shown in FIG. 1.

In the nozzle head 11, a plurality of nozzles 14 for discharging small droplets of ink 12 are arranged in an axial direction. The ink 12 stored in an ink tank 18 is supplied to the nozzle head 11 through an ink supply tube 17 and is intermittently discharged as small droplets from the respective nozzles 14 of the nozzle head 11 driven by a nozzle head driving portion 15. A method for discharging the ink from the nozzle 14 is not specifically limited. For example, various methods such as a piezoelectric method, a thermal-ink-jet method, and an air-jet method can be used. The nozzle head driving portion 15 has a structure corresponding to the employed ink-discharging method. Moreover, any of continuous printing and on-demand printing can be employed as a printing method of the nozzle head 11.

The ink 14 is a resin composition containing a photocrosslinking resin as a base resin, for example, and contains an organic solvent in an appropriate proportion, if necessary. The present embodiment uses a resin composition (UV-curing ink) containing as a base resin a UV-curing resin that starts polymerization by radiation of ultraviolet rays and is fixed, as a preferable resin composition. A UV radiation lamp is used as the light source 21 in accordance with the use of the UV-curing resin.

Examples of the UV-curing resin constituting the base resin of the UV-curing ink include imido acrylates, and thiol-ene compounds such as cyclic polyene compounds and polythiol compounds in addition to radically polymerizable monomers or oligomers, and cationically polymerizable monomers. Among them, it is preferable to use radically polymerizable monomers or oligomers or cationically polymerizable monomers. Examples of the radically polymerizable monomers include acrylate and metacrylate monomers that are monofunctional, difunctional, or polyfunctional. Examples of the radically polymerizable monomers include urethane acrylates, epoxy acrylates, polyester acrylates, and unsaturated polyesters. Examples of the cationically polymerizable monomers include bisphenol A epoxy resins, phenol novolac epoxy resins, alicyclic epoxy resins, and oxetane resins such as 3-ethyl-3-hydroxymethyl-oxetane, 1,4-bis{[(3-ethyl-3-oxetanyl)methoxy]methyl}benzene, 3-ethyl-3-(phenoxymethyl)oxetane, di[1-ethyl(3-oxetanyl)]methyl ether, 3-ethyl-3-(2-ethylhexyloxymethyl)oxetane, 3-ethyl-3-{[3-(triethoxy-silyl)propoxy]methyl}oxetane can be used. The above UV-curing resin can be used as the base resin alone. Alternatively, a mixture of two or more of the above UV-curing resins can be used as the base resin.

A photo-initiator such as a radical type photo-initiator that initiates polymerization by radiation of ultraviolet rays or a cationic photo-initiator is added to the above base resin. Examples of the radical type photo-initiator includes hydrogen abstraction type photo-initiators typified by benzophenone, methyl o-benzoin-benzoate, 4-benzoyl-4′-methyldiphenylsulfide, ammonium salts of benzophenone, isopropylthioxanthone, diethylthioxanthone, and ammonium salts of thioxanthone. Alternatively, examples of the radical type photo-initiator includes intermolecular cleavage type photo-initiators typified by benzoin derivatives, benzyl dimethyl ketal, α-hydroxyalkylphenon, α-aminoalkylphenon, acylphosphine oxide, monoacylphosphine oxide, bisacylphosphine oxide, acrylphenylglyoxylate, diethoxy acetophenone, and titanocene compounds. Examples of the cationic photo-initiators include polyaryl sulfonium salts typified by triphenyl sulfonium hexafluoro antimonate, triphenyl sulfonium hexafluoro phosphate, SP-170 and SP-150 (both manufactured by Asahi Denka Co., Ltd.), FC-508 and FC-512 (both manufactured by 3M Company), and UVE-1014 (manufactured by General Electric Company); mixed triallyl sulfonium hexafluoro phosphate salts typified by Uvacure 1590 and 1591 (both manufactured by DAICEL-UCB Co. Ltd.); metallocene compounds such as Irg-261 (manufactured by Ciba-Geigy Corporation); and polyaryl iodonium salts typified by diphenyl iodonium hexafluoro antimonate, p-nonylphenyl phenyl iodonium hexafluoro antimonate, and 4,4′-diethoxyphenyl iodonium hexafluoro antimonate. The above photo-initiator can be used alone or in combination with other photo-initiator.

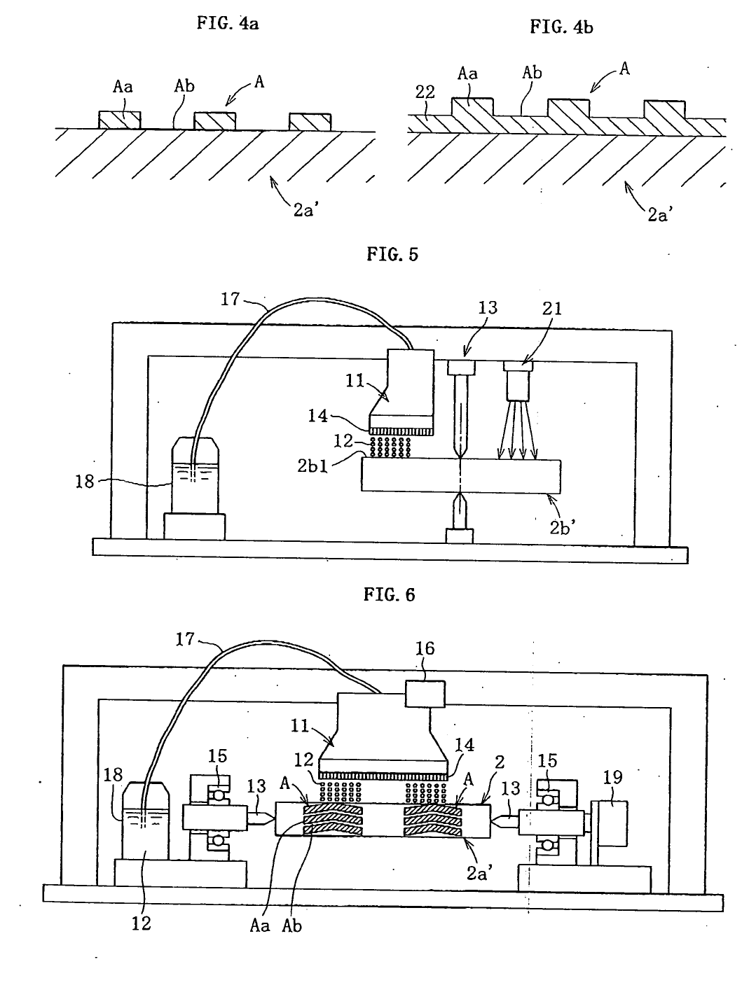

In the above structure, when the nozzles 14 of the nozzle head 11 discharge small droplets of ink 12 while the material 2a′ is rotated, the small droplets of ink 12 reach a predetermined position on the outer circumferential surface of the material 2a′. Thus, a dynamic pressure generating portion A is formed which includes regions (convex backs) Aa each formed by an aggregate of the small droplets and regions (dynamic pressure generating grooves) Ab that are not covered with the ink, as shown in FIG. 4a. The regions Aa and Ab are alternately arranged in a circumferential direction. Formation of the dynamic pressure generating portion A is performed in such a manner that it makes progress in the circumferential direction on the outer circumferential surface of the material 2a′ with the rotation of the material 2a′. When a printed portion reaches a region opposed to the light source 21 after traveling along the circumferential direction to some extent (traveling halfway around the material 2a′ in the shown example), the ink 12 is polymerized by radiation of ultraviolet rays to be cured. The curing of the ink also makes progress in the circumferential direction of the material 2a′ gradually with the rotation of the material 2a′.

The nozzle head 11 is slid in the axial direction and the material 2a′ is rotated to make one to dozens of revolutions, while the discharge and stop of the ink 12 from the nozzle 14 are switched. In this manner, the dynamic pressure generating portion A is formed on the outer circumferential surface of the material 2a′ entirely. When the printing of the dynamic pressure generating portion A is finished and all parts of the ink 12 are cured, the rotary drive portion 19 is stopped and the material 2a′ is then detached from the holding portions 13.

During the printing, the nozzle head 11 can be arranged at a fixed position, instead of being slid in the axial direction. Moreover, a single nozzle head 11 is used in the shown example. However, a plurality of nozzle heads 11 can be arranged at a plurality of positions in the axial direction or the circumferential direction, respectively. In addition, a plurality of materials 2a′ may be connected in series, as shown in FIG. 3. In this case, the materials 2a′ are rotated simultaneously while one or more nozzle heads 11 are slid in the axial direction. In this manner, the dynamic pressure portions A are printed on the respective materials 2a′. In this case, the materials 2a′ can be surely arranged to be coaxial by fitting a convex portion 2a2 provided at one end of the material 2a′ into a concave portion provided on the adjacent material 2a′, for example.

In the ink-jet type printing described above, small droplets of ink 12 can be accurately discharged in accordance with a pattern that is programmed in advance. The thickness of an ink layer obtained by the printing can be accurately controlled. Therefore, it is possible to form a highly accurate dynamic pressure generating portion A by the cured ink with a required depth of dynamic pressure generating grooves (several microns to several tens of microns) ensured. Thus, the printed dynamic pressure generating portion A can be used as a bearing surface of a dynamic bearing as it is. In this case, an etching process and a process for removing the cured ink that are essential to a conventional technique can be eliminated. Thus, the forming process of the dynamic pressure generating portion A can be simplified and a required processing cost can be reduced. Moreover, it is unnecessary for the ink to have corrosion resistance. Therefore, freedom of selecting inks to be used can be improved.

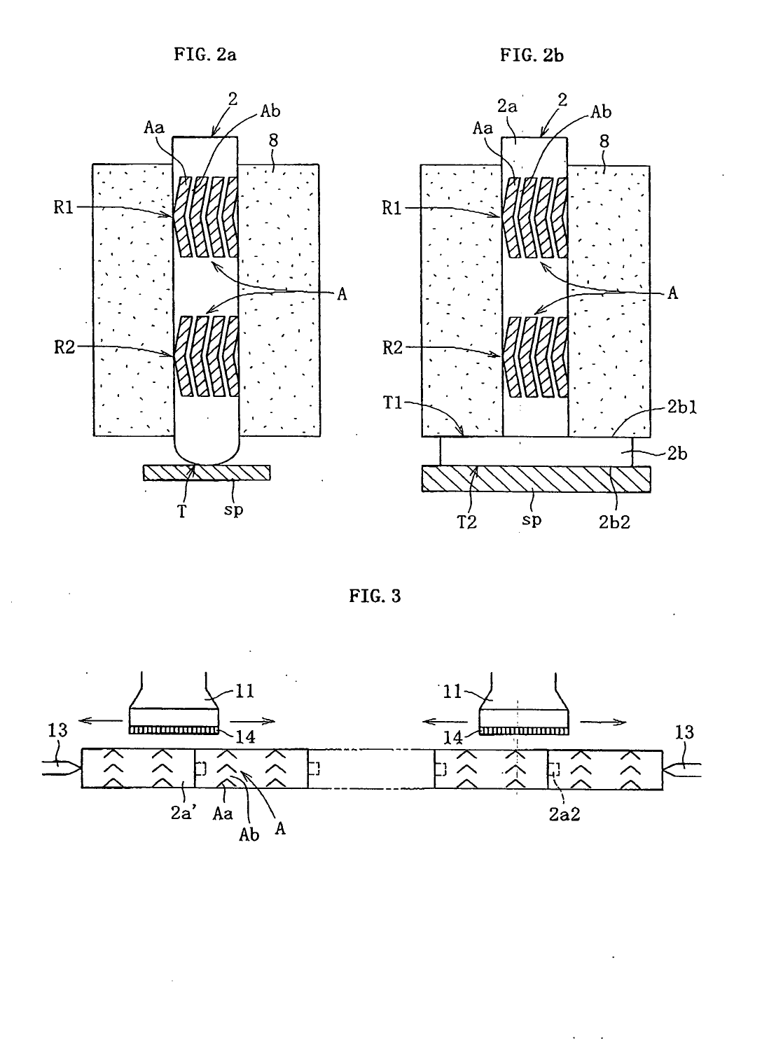

In this case, the ink 12 on the outer circumferential surface of the shaft member 2 comes into contact with a member on the other side (e.g., a bearing sleeve 8 in FIG. 2) in a sliding manner in theory. Thus, importance of the abrasion resistance of the material 2a′ is not high among the required properties of the material 2a′. Therefore, it is possible to improve the freedom of selecting the material of the shaft member 2 and eliminate the heat treatment to be performed for improving the abrasion resistance. Accordingly, the shaft member can be formed from a metal that is not subjected to a heat treatment. This can reduce a required material cost.

Moreover, the ink 12 in a first printed region does not overlap with the ink 12 in a last printed region. The first printed region and the last printed region can be made to continue with a uniform thickness. Especially, a photocrosslinking resin and a UV lamp are used as the ink 12 and the light source 21, respectively, so as to cure the printed region in a short period of time in the present embodiment. Thus, the printed dynamic pressure generating portion A can be maintained with high accuracy while keeping a good silhouette. In addition, the required amount of ink 12 is the amount for forming the backs Aa of the dynamic pressure generating portion A only. Therefore, wasteful use of the ink 12 can be avoided and the material cost can be reduced.

In the ink-jet printing, the material 2a′ does not come into contact with a printing mold as in a conventional printing machine. Thus, deterioration of the printing accuracy caused by wear in a contact portion can be avoided. Therefore, the accuracy of the dynamic pressure generating groove can be stably ensured in mass production. Furthermore, a printing mold, a printing screen for holding the printing mold, and a mechanism for moving the printing mold in accordance with the rotation of the material 2a′ are not required. This can make the configuration of a forming device simple.

Especially, in the configuration of FIG. 1, the first printed region goes back to a position opposed to the nozzle head 11 after being cured by ultraviolet rays radiated from the light source 21. Thus, a situation can be prevented from occurring where an ink that is not cured sufficiently overlaps and adversely affects the dynamic pressure generating portion A. In addition, since the nozzle head 11 and the light source 21 are arranged to be opposed to each other with the material 2a′ interposed therebetween, ultraviolet rays from the light source 21 are blocked by the material 2a′ and do not reach the region on the material 2a′ that is opposed to the nozzle head 11. Therefore, a curing action of the ultraviolet rays does not act on the nozzle head 11. That is, clogging of the nozzle 14 with cured ink, and the like can be prevented. Thus, the printing can be efficiently performed.

Needless to say, etching may be performed after the dynamic pressure generating portion A is printed, if necessary. In this case, the shaft member 2 with the dynamic pressure generating grooves can be formed by removing the ink, after the dynamic pressure generating grooves Ab are formed by a corrosive action.

FIG. 4a illustrates a case where a region that is not covered with the ink forms the dynamic pressure groove Ab. Alternatively, a region covered with the ink (ink layer) 22 can form the dynamic pressure groove Ab, as shown in FIG. 4b. In this case, the outer circumferential surface of the material 2a′ is entirely covered with the ink layer 22 and the convex backs Aa are formed on the ink layer 22 integrally therewith. Therefore, it is possible to increase an area where the ink adheres to the material 2a′ and to suppress reduction of endurance time caused by separation of the ink or the like.

The material 2a′ is driven to rotate in the above description. Alternatively, the dynamic pressure generating portion A may be printed and cured, while the material 2a′ is fixed and the nozzle head 11 and the light source 21 are driven to rotate around the material 2a′.

FIGS. 2a and 2b are cross-sectional views generally showing a fluid dynamic bearing device using the shaft member 2 formed by the material 2a′ that is manufactured by the aforementioned process.

Each of the bearing devices shown in FIGS. 2a and 2b includes the dynamic pressure generating portion A formed on the outer circumferential surface of the shaft member 2 by the aforementioned forming device.

A radial bearing gap is formed between that dynamic pressure generating portion A and an inner circumferential surface of a bearing sleeve 8 that is opposed to the dynamic pressure generating portion A. The bearing sleeve 8 is formed to be cylindrical from a sintered metal impregnated with a soft metal or an oil. The shaft member 2 is inserted in the bearing sleeve 8. When the shaft member 2 is rotated (the bearing sleeve 8 may be rotated), the dynamic pressure generating grooves Ab cause a dynamic pressure action of lubricating fluid (oil, air, magnetic fluid, or the like) in the radial bearing gap. Thus, radial bearing portions R1 and R2 are constituted which support the shaft member 2 in a radial direction in a non-contact manner with a pressure generated by the dynamic pressure action in the radial bearing gap.

In the bearing device shown in FIG. 2b, a thrust bearing portion T is constituted that brings one end of the shaft member 2 into contact with a thrust plate Sp so as to support the shaft member 2 in a thrust direction in a contact manner.

On the other hand, thrust bearing portions T1 and T2 are formed by dynamic bearings in the bearing device shown in FIG. 2b. The shaft member 2 is formed by a shaft portion 2a and a flange portion 2b that is formed together with the shaft portion 2a as one piece or is formed as a separate part from the shaft portion 2a. A dynamic pressure action of fluid is caused in thrust bearing gaps between one end face 2bl of the flange portion 2b and an end face of the bearing sleeve 8 and between the other end face 2b2 and an end face of the thrust plate Sp. This dynamic pressure action generates a pressure that supports the shaft member 2 in both thrust directions in a non-contact manner.

In this case, one of the end faces 2bl and 2b2 of the flange portion 2b serving as the dynamic pressure generating portions may be formed by existing means such as press, or by performing ink-jet printing and hardening the ink, like the dynamic pressure generating portions A of the radial bearing portions R1 and R2.

FIG. 5 is an exemplary forming device for forming a dynamic pressure generating portion on the upper one 2b1 of the end faces 2b1 and 2b2 of the flange portion 2b (a forming device for forming the dynamic pressure generating portion on the lower end face 2b2 has the same configuration as the forming device for forming the dynamic pressure generating portion on the upper end face 2b1 and therefore the description thereof is omitted). Main components of this forming device are the same as those of the forming device shown in FIG. 1. However, this forming device is different in that the nozzle head 11 and the light source 21 are arranged to be opposed to the upper end face 2b1 of a material 2b′ that is driven to rotate at different positions in the circumferential direction.

While the material 2b′ held by the holding portion 13 is rotated, the nozzle head 11 is made to slide in both ways in a radial direction and discharge the ink 12 from the nozzle 14. As a result, small droplets of the ink 12 reach a predetermined position on the upper end face 2b1 of the material 2b′. An aggregate of those small droplets forms a dynamic pressure generating portion on the upper end face 2b1 of the material 2b′, which includes dynamic pressure generating grooves arranged spirally, for example. Printing of the dynamic pressure generating portion is performed in such a manner that it makes progress gradually in the circumferential direction with the rotation of the material 2b′. When a printed part reaches a region opposed to the light source 21, the ink 12 irradiated with ultraviolet rays is polymerized and sequentially cured. The shaft member is rotated to make one to dozens of revolutions, while the discharge and stop of the ink 12 from the respective nozzle 14 are switched in an appropriate manner. In this manner, the dynamic pressure generating portion is formed over the entire circumference of the upper end face 2b1 of the material 2b′.

In the above description, a case is described where the dynamic pressure generating portions A are formed on the outer circumferential surface of the shaft member 2 as the radial bearing portions R1 and R2. Similarly, the dynamic pressure generating portion A can be formed on the inner circumferential surface of the bearing sleeve 8. In this case, the nozzle head 11 and the light source 21 are arranged to be opposed to the inner circumferential surface of a material of the bearing sleeve 8 (a sleeve-like material) at different positions in the circumferential direction.

An oil such as a lubricating oil is frequently used as a lubricating fluid in a fluid dynamic bearing device. In this case, when the dynamic pressure generating portion A is formed from a hardened ink (resin composition) as described above, the resin composition forming the dynamic pressure generating portion A is always soaked in the oil. Thus, when the oil resistance of the resin composition is insufficient, swelling of the resin composition deteriorates an elastic modulus of the dynamic pressure generating portion or the like, and adversely affects the bearing performance.

Therefore, it is desirable to consider the oil resistance when the base resin of the ink 12 is selected. The oil resistance of the base resin can be evaluated from a difference between its solubility parameter (SP value) and a solubility parameter of a lubricating oil that comes into contact with the surface of the dynamic pressure generating portion A. The inventors have found that the necessary oil resistance could be obtained when the absolute value of the above difference is 1.0 or more.

Examples of the lubricating oil mainly include synthetic lubricating oils. Examples of the synthetic lubricating oil include a synthetic hydrocarbon oil, a polyalkylene glycol oil, a diester oil, a polyol ester oil, a phosphate oil, a silane oil, a silicate oil, a silicone oil, a polyphenylether oil, and a fluorocarbon oil. When a used environment of the dynamic bearing is considered, among them the diester lubricating oil is preferable which has a relatively low evaporation rate and a low viscosity. Examples of the diester lubricating oil include dioctyl adipate, dioctyl axelate, dioctyl sebacate, diisooctyl adipate, and diisodecyl adipate. The above listed oils and the above listed base resins (UV-curing resins) can be used in combination, as long as an absolute value of the difference of the solubility parameter (SP value) between them is 1.0 or more.

The inventors performed a rubbing test for each of combinations of resin compositions and oils which had an absolute value of the difference of the solubility parameter smaller than 1.0, and combinations of resin compositions and oils which had an absolute value of the difference of the solubility parameter equal to or larger than 1.0, thereby comparing the oil resistance. The details of the experiment are as follows.

[Material Composition of Resin Composition]

Aronoxetane OXT-212 (SP value: 8.1) manufactured by Toagosei Co., Ltd., which was one of cationically polymerizable monomers, 3-ethyl-3-(2-ethylhexyloxymethyl)oxetane, was used as a UV-curing resin that served as a base resin of a resin composition 12. Moreover, Aronoxetane OXT-101 (SP value: 10.9) manufactured by Toagosei Co., Ltd., which was one of cationically polymerizable monomers, 3-ethyl-3-hydroxymethyl-oxetane was used as another base resin. Uvacure 1590 manufactured by DAICEL-UCB Co., Ltd., which was mixed triallyl sulfonium hexafluoro phosphate salts serving as a cationic photo-initiator, was added to each of the above base resins. 3 parts of the initiator were added to 100 parts of each base resin, thereby obtaining resin compositions (referred to as resin composition No. 1 and resin composition No. 2 corresponding to the former base resin and the latter base resin, respectively).

[Oil Under Test]

Dioctyl adipate (DOA) that was one of diester lubricating oils was used as an oil under test. In this test, Reagent Code No. 047-24191 (SP value: 8.8) manufactured by Wako Pure Chemical Industries, Ltd. was used.

[Formation of an Exemplary Sample and a Comparative Sample]

Test samples were formed by applying the two resin compositions (Nos. 1 and 2) onto substrates having a surface roughness Ra of 0.2 formed of SUS304 by ink-jet printing and then curing those resin compositions to fix them on the substrates, respectively. One of the test samples, having the resin composition No. 1 (the absolute difference of the SP value: 0.7) fixed on the substrate, was used as a comparative sample, which contained the base resin having an absolute value of the difference of the solubility parameter with respect to the above oil under test smaller than 1.0. The other test sample, having the resin composition No. 2 (the absolute difference of the SP value: 2.1) fixed on the substrate, was used as an exemplary sample, which contained the base resin having an absolute value of the difference of the solubility parameter with respect to the above oil under test equal to or larger than 1.0.

[Rubbing Test]

Each of the exemplary sample and the comparative sample was soaked in the above oil under test (DOA) at a temperature of 100□ for 100 hours. Then, each sample was taken out, the oil adhered was wiped off, and was rubbed with a pair of tweezers formed of SUS in such a manner that the sample was not scratched.

[Results]

In the exemplary sample having the resin composition (No. 2) fixed on the metal substrate, in which the absolute difference of the SP value between the base resin and the oil was 1.0 or more, the resin part did not come off the substrate in the above rubbing test. On the other hand, in the comparative sample having the resin composition (No. 1) fixed on the metal substrate, in which the absolute difference of the SP value was smaller than 1.0, the resin part peeled off the substrate in the rubbing test.

As is apparent from the above test results, when the absolute difference between the solubility parameter of the base resin of the ink 12 and that of the lubricating oil is set to 1.0 or more, it is possible to suppress wear of the dynamic pressure generating portion A caused by swelling of the resin composition and ensure the stable performance of the bearing over a long period of time.

In the above description, a case is described where a photocrosslinking resin is used as the base resin of the ink 12 as an example. Alternatively, a thermosetting resin can be used as the base resin.

Any thermosetting resin can be used, as long as it has heat resistance. Examples thereof include phenol resins, epoxy resins, alkyd resins, melamine resins, and unsaturated polyester resins. Those resins can be used while being solved in a solvent, if necessary. Various additives such as an agent for initiating a thermosetting reaction may be added to the thermosetting resin, if necessary.

In case of using a solvent, the solvent is not specifically limited, as long as it can dissolve the thermosetting resin. In case of using a phenol resin as the thermosetting resin, examples thereof include an alcohol solvent such as ethanol, a ketone solvent such as methyl ethyl ketone, and an ester solvent such as butyl acetate. In case of using an epoxy resin as the thermosetting resin, examples thereof include an aromatic solvent such as toluene and xylene, a ketone solvent, and an ester solvent. In case of using an alkyd resin as the thermosetting resin, examples thereof include an aromatic solvent and an ester solvent.

FIG. 6 generally shows a forming device that uses a thermosetting resin as the base resin of the ink 12. This forming device does not require the light source 21, unlike the forming device shown in FIG. 1. While the material 2a′ that is supported at both ends by the supporting portions 13 is rotated, the nozzle 14 discharges the ink 12. Thus, small droplets of the ink 12 reach a predetermined position on the outer circumferential surface of the material 2a′. The dynamic pressure generating groove generating portion A having a herringbone pattern, for example, is formed on the outer circumferential surface of the material 2a′. In the portion A, the backs Aa covered with aggregates of the small droplets of the ink and the dynamic pressure generating grooves Ab that are not covered with the ink are arranged. In this formation of the dynamic pressure generating portion A, supply and stop of the ink 12 from the nozzle 14 are switched at predetermined timings in an appropriate manner. This formation of the dynamic pressure groove pattern is performed in such a manner that the formation makes progress gradually on the outer circumferential surface of the material 2a′ in the circumferential direction with the rotation of the material 2a′.

From a viewpoint of forming a highly accurate dynamic pressure generating portion, it is desirable to place in the forming device the material 2a′ that has been heated in advance so as to allow hardening of the ink 12 to begin from an adhering interface between the ink 12 and the material 2a′ at landing of the ink 12 on the material 2a′. In this case, a droplet of the ink 12 is hardened at landing of the droplet on the material 2a′. Therefore, the highly accurate dynamic pressure generating portion can be efficiently formed while preventing separation and falling of the ink 12 associated with the rotation of the material 2a′ from occurring.

In the case where the ink 12 is hardened only by using ultraviolet rays as in the forming device shown in FIG. 1, for example, the hardening of the ink 12 begins from the surface of the ink 12. Thus, the rotation of the material 2a′, i.e., the printing makes progress, while an adhering state of the ink 12 at the interface is unstable. Moreover, since the surface of the ink 12 is cured first, gas or the like contained in the ink 12 cannot escape to the outside. Thus, the ink 12 may be cured with the gas or the like contained therein. When the material 2a′ in such a state is incorporated and used in a fluid dynamic bearing device, the gas or the like contained in the ink may expand due to the temperature increase during an operation of the bearing. In this case, destruction of a pattern may be caused by break of the ink droplet or the like. On the other hand, if the material 2a′ is heated in advance, the hardening of the ink begins from the adhering interface between the ink and the material 2a′. Thus, the gas or the like contained in the ink 12 can go out and break of the ink droplet or the like can be avoided. In addition, the printing is made to proceed while an adhering force is maintained at the interface. Therefore, a highly accurate pattern can be formed.

Any of so-called external heating and internal heating can be employed for heating the material 2a′. The external heating is a heating method in which heating from a heat source arranged outside an object (material 2a′ in this case) is gradually carried out from a surface of the object to the inside thereof by using conduction of heat, radiation, convection, and the like. For example, heating over an open fire, hot-air heating, heating using steam, electric heating, and the like are known as the external heating. The internal heating is a heating method in which an object itself is made to generate heat so as to carry out heating in the inside of the object and in the outside of the object in parallel. For example, heating by electromagnetic waves that uses radio-frequency waves or microwaves is an example of the internal heating.

In the present embodiment, a case is described as an example where the dynamic pressure generating portion is formed by using the material 2a′ that has been heated in advance. Alternatively, a heat source is arranged in the forming device and the dynamic pressure generating portion can be formed by performing the printing while the material is heated thereby. Moreover, both of those heating methods can be used together. In this case, the hardening of resin can be carried out from the surface of the ink droplet reaching the material 2a′ and the interface between the ink and the material 2a′. Therefore, a cycle time can be reduced. This also reduces the fabrication cost.

In the above description, a case is described as an example where the ink 12 is thermally set. Alternatively, this thermosetting of the ink can be combined with photocrosslinking, preferably UV-curing. In this case, a hardening rate of the ink 12 can be made larger. In case of employing UV-curing only (see FIG. 1), a shape and an arranged position of a light guide have to be designed carefully in order to uniformly cure the ink. However, in case of using thermosetting and photocrosslinking together, this kind of care is not necessary because the light source 21 is arranged in order to increase the hardening rate.

An ink obtained by adding a hardening agent (a polymerization initiator, a catalyst for initiating polymerization, and the like) to a base resin is used as the ink 12. As the base resin of the ink 12, radically polymerizable monomers, radically polymerizable oligomers, and cationically polymerizable monomers can be preferably used. As one example of the base resin of the ink 12, a mixture of an alicyclic epoxy resin such as CELLOXIDE 2021P (manufactured by Daicel Chemical Industries Ltd.), which is one of cationically polymerizable monomers, and an alicyclic epoxy diluent such as CELLOXIDE 3000 (manufactured by Daicel Chemical Industries Ltd.) can be used. As the ink 12, an ink obtained by adding 3 to 5 parts of an aromatic sulfonium salt such as SUNAID SI-110, SI-180, SI-100L, SI-80L, or SI-60L (all manufactured by Sanshin Chemical Industry Co., Ltd.) as an initiator for thermosetting and photocrosslinking to 100 parts of the above base resin can be used. As the hardening agent to be added to the base resin, a mixture of a thermosetting initiator such as SUNAID SI-H40 or SUNAID SI-L150 (both manufactured by Sanshin Chemical Industry Co., Ltd.) and a photocrosslinking (polymerization) initiator formed by a mixture of triallyl sulfonium hexafluoro phosphate salts typified by Uvacure 1590 or Uvacure 1590 (both manufactured by DAICEL-UCB Co., Ltd.) can be used, other than the aforementioned initiator for thermosetting and photocrosslinking.

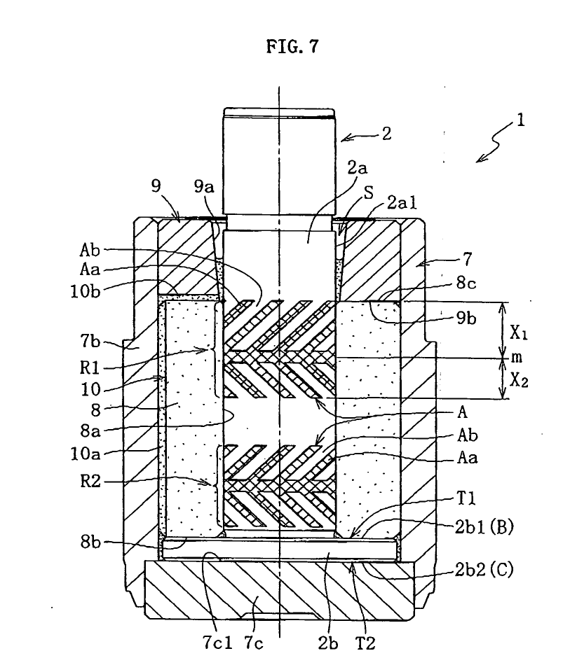

FIG. 7 shows a specific structure of an exemplary fluid dynamic bearing device 1 incorporating the shaft member 2 manufactured by the aforementioned process therein. This fluid dynamic bearing device 1 includes the shaft member 2 having a shaft portion 2a at the center of rotation, a housing 7 in the form of a cylinder with a bottom, a cylindrical bearing sleeve 8 that is fixed to an inner circumferential surface of the housing 7, and a seal portion 9 fixed to an opening of the housing 7. The shaft portion 2a of the shaft member 2 can be inserted into the bearing sleeve 8.

The shaft member 2 includes the solid-core shaft portion 2a and a flange portion 2b provided at one end of the shaft portion 2a. The flange portion 2b can be formed together with the shaft portion 2a as one part, or can be formed as a separate part from the shaft portion 2a. In the example of FIG. 7, a case is illustrated where the flange portion 2b is formed as a separate part from the shaft portion 2a. In the present embodiment, dynamic pressure generating portions A in a herringbone shape are formed on an outer circumferential surface 2a1 of the shaft portion 2a at two positions that are separated from each other in the axial direction. Each dynamic pressure generating portion A contains a plurality of dynamic pressure generating grooves Ab and convex backs Aa for sectioning and forming the dynamic pressure generating grooves Ab. The dynamic pressure generating portions A are formed by performing the ink-jet printing on the surface of the material 2a′ and hardening the ink, as described above.

In the upper dynamic pressure generating portion A, the dynamic pressure generating grooves Ab are formed to be asymmetric in the axial direction with respect to the center m, and the axial dimension X1 of a region upper than the center m is larger than the axial dimension X2 of a region lower than the center m. Thus, while the shaft member 2 is rotated, a pull-in force (pumping force) of a lubricating oil generated by the dynamic pressure generating grooves Ab is relatively larger in the upper dynamic pressure generating portion A than in the lower dynamic pressure generating portion A that is symmetric in the axial direction. Please note that a desired number of dynamic pressure generating portions A can be formed. For example, the dynamic pressure generating portion A can be formed at a single location or at each of three or more locations in the axial direction.

A first thrust bearing surface B and a second thrust bearing surface C are formed on an upper end face 2b1 and a lower end face 2b2 of the flange portion 2b, respectively. Each of the first and second thrust bearing surfaces B and C includes a spiral dynamic pressure generating portion, for example, which is formed by dynamic pressure generating grooves and backs for sectioning and forming the dynamic pressure generating grooves. The first thrust bearing surface B is opposed to a lower end face 8b of the bearing sleeve 8 that will be described later, with a first thrust bearing gap interposed therebetween. The second thrust bearing surface C is opposed to an upper end face 7c1 of the bottom portion 7c of the housing 7 that will be described later, with a second thrust bearing gap interposed therebetween. The dynamic pressure generating portions of the first and second thrust bearing surfaces B and C can be formed by means that is usually adopted, such as press working, or can be formed with the forming device shown in FIG. 5 by performing the printing using the ink 12 and then hardening the ink 12. Those thrust bearing surfaces B and C having the dynamic pressure generating portions can be formed not only on the end faces 2b1 and 2b2 of the flange portion 2b but also on the lower end face 8b of the bearing sleeve 8 and the upper end face 7c1 of the bottom 7c, that are opposed to the end faces 2b1 and 2b2 of the flange portion 2b, respectively, in a similar manner.

The bearing sleeve 8 is formed from a porous body formed of a sintered metal in a cylindrical shape, especially, a porous body formed of an oil-containing sintered metal obtained by impregnating a sintered metal mainly containing copper with a lubricating oil (or a lubricating grease). The shaft member 2 is inserted into an inner circumferential surface 8a of the bearing sleeve 8. In the present embodiment, the inner circumferential surface 8a of the bearing sleeve 8 is formed as a smooth cylindrical surface and is opposed to the dynamic pressure generating portion A formed on the outer circumferential surface 2a1 of the shaft member 2 with a radial bearing gap interposed therebetween.

The housing 7 includes a side portion 7b that is approximately cylindrical and has openings at both ends, and the bottom portion 7c. In the present embodiment, the side portion 7b and the bottom portion 7c are separate parts from each other. For example, the side portion 7b is formed to be approximately cylindrical by injection molding of a resin composition, and the bottom portion 7c is formed from a soft metal and is pressed to be approximately column-shaped. The bottom portion 7c is attached to a lower opening of the side portion 7b by performing at least one of bonding and press fitting, thereby forming the housing 7 in the form of a cylinder that has a bottom and is closed at one end. Alternatively, the side portion 7b and the bottom portion 7c can be formed integrally with each other from a resin composition or a metal material.

The seal member 9 is formed to be annular from a metal material or a resin material. In the present embodiment, the seal member 9 is formed as a separate part from the housing 7 and is fixed to an upper opening 7a of the side portion 7b of the housing 7 by press fitting, bonding, or the like. An inner circumferential surface 9a of the seal member 9 is tapered in such a manner that its diameter becomes larger upward. An annular seal space S is formed between the inner circumferential surface 9a and the outer circumferential surface 2a1 of the shaft portion 2a which is opposed to the inner circumferential surface 9a. The seal space S has a dimension in the radial direction that gradually becomes larger upward. An inner space of the fluid dynamic bearing device 1 that is sealed with the seal member 9 is lubricated with a lubricating oil as a lubricating fluid. Thus, the inside of the fluid dynamic bearing device 1 is filled with the lubricating oil. In this state, an oil surface of the lubricating oil is kept within a range of the seal space S. The seal member 9 may be formed integrally with the housing 7 in order to reduce the number of parts and assembly processes.

When the shaft member 2 is rotated in the fluid dynamic bearing device 1 having the above configuration, the dynamic pressure generating portions A that are formed to be away from each other on the outer circumferential surface 2a1 of the shaft portion 2a are opposed to the inner circumferential surface 8a of the bearing sleeve 8 with radial bearing gaps interposed therebetween, respectively. With the rotation of the shaft member 2, the lubricating oil in each radial bearing gap generates a dynamic pressure action. The thus generated pressure supports the shaft member 2 in a non-contact manner to be freely rotatable in the radial direction. Thus, a first radial bearing portion R1 and a second radial bearing portion R2 are formed that support the shaft member 2 in a non-contact manner in such a manner that the shaft member 2 is freely rotatable in the radial direction.

The first thrust bearing surface B formed on the upper end face 2b1 of the flange portion 2b of the shaft member 2 is opposed to the lower end face 8b of the bearing sleeve 8 with the first thrust bearing gap interposed therebetween. The second thrust bearing surface C formed on the lower end face 2b2 of the flange portion 2b is opposed to the upper end face 7c1 of the bottom portion 7c of the housing 7 with the second thrust bearing gap interposed therebetween. With the rotation of the shaft member 2, the lubricating oil in both the thrust bearing gaps generates a dynamic pressure action. The thus generated pressure supports the shaft member 2 in a non-contact manner such that the shaft member 2 is freely rotatable in the thrust direction. In this manner, the first thrust bearing portion T1 and the second thrust bearing portion T2 are formed that support the shaft member 2 in a non-contact manner such that the shaft member 2 is freely rotatable in both of the thrust directions.

In the fluid dynamic bearing device 1 of the present embodiment, the pressure of the lubricating oil in the thrust bearing gap may become extremely large for some reasons during an operation of the bearing and may generate a pressure difference between the lubricant pressure and a pressure in the seal space S. This pressure difference may cause generation of bubbles in the lubricating oil, which may cause leak of the lubricating oil and generation of vibration. In order to prevent the above situation from occurring, a circulation path 10 for allowing the thrust bearing gap to be in communication with outside air is formed inside the bearing device. When the circulation path 10 is provided, it is possible to keep a good balance between the pressure in the seal space S and the pressure in the thrust bearing gap, thus the above troubles caused by the pressure difference can be avoided. The circulation path 10 includes a circulation groove 10a provided between the outer circumferential surface of the bearing sleeve 8 and the inner circumferential surface of the housing 7 and a radially-extending groove 10b provided between the upper end face 8c of the bearing sleeve 8 and the lower end face 9b of the seal member 9. The radially-extending groove 10b extends from an upper end of the circulation groove 10a to the seal space S. FIG. 7 shows a case where the circulation groove 10a is formed on the outer circumference of the bearing sleeve 8. Alternatively, the circulation groove 10a can be formed on the inner circumferential surface of the side portion 7b of the housing 7. Moreover, FIG. 7 shows the radially-extending groove 10b that is formed on the lower end face 9b of the seal member 9 as an example. Alternatively, the radially-extending groove 10b can be formed on the upper end face 8c of the bearing sleeve 8.

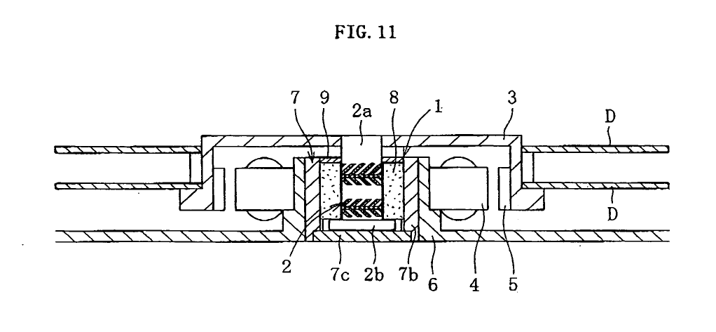

FIG. 11 is a conceptual diagram of an exemplary spindle motor for information equipment, which incorporates the fluid dynamic bearing device 1 shown in FIG. 7 therein. The spindle motor for information equipment is used in a disc drive such as an HDD, and includes the fluid dynamic bearing device 1, a disc hub 3 attached to the shaft member 2 of the fluid dynamic bearing device 1, a stator coil 4 and a rotor magnet 5 that are opposed to each other with a radially-extending gap interposed therebetween, for example, and a bracket 6. The stator coil 4 is attached to an outer circumference of the bracket 6, and the rotor magnet 5 is attached to an inner circumference of the disc hub 3. The disc hub 3 holds one or more discs D such as magnetic discs at its outer circumference. The housing 7 of the fluid dynamic bearing device 1 is mounted on the inner circumference of the bracket 6. When a current flows through the stator coil 4, an exciting force generated between the stator coil 4 and the rotor magnet 5 rotates the rotor magnet 5. Thus, the disc hub 3 and the shaft member 2 are rotated with the rotation of the rotor magnet 5.

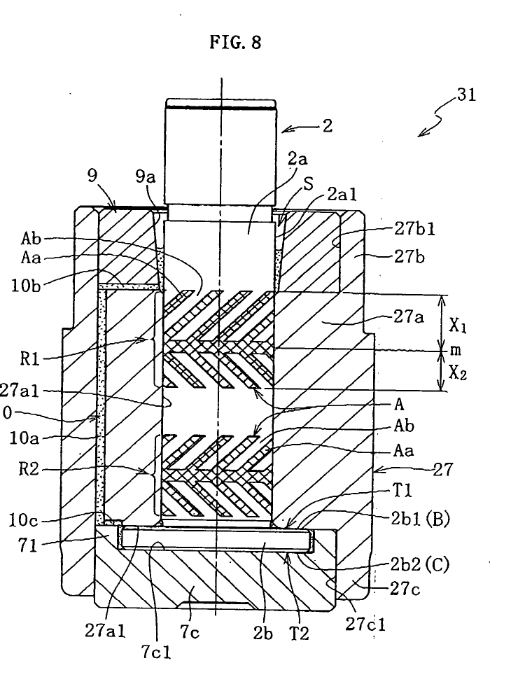

FIG. 8 shows a fluid dynamic bearing device 31 in which a bearing member 27 is formed by integrating a part corresponding to the bearing sleeve 8 and a part corresponding to the housing 7 in the embodiment of the fluid dynamic bearing device 1 shown in FIG. 7 with each other. In the following description, parts and arrangements that have the same functions as those in the fluid dynamic bearing device 1 shown in FIG. 7 are labeled with the same reference numerals as those in FIG. 7, and the redundant description is omitted.

The bearing member 27 can be formed by forging a metal, injection molding a resin, or MIM. The bearing member 27 in the shown example includes a sleeve portion 27a, a seal attachment portion 27b arranged above the sleeve portion 27a, and a closing portion 27c arranged above the sleeve portion 27a. An inner circumferential surface 27a1 of the sleeve portion 27a has a diameter smaller than those of an inner circumferential surface 27b1 of the seal attachment portion 27b and an inner circumferential surface 27c1 of the closing portion 27c, and is opposed to two dynamic pressure generating portions A of the shaft member 2. The seal member 9 is fixed to the inner circumferential surface 27b1 of the seal attachment portion 27b of the bearing member 27, and the bottom portion 7c is fixed to the inner circumferential surface 27c1 of the closing portion 27c. The above fixing is achieved by press fitting, bonding, or combination of them. The bottom portion 7c includes a cylindrical portion 71 at its outer circumference, which projects upward. The cylindrical portion 28a is in contact with an end face 27a1 of the sleeve portion 27a. A radially-extending groove 10c is formed between the cylindrical portion 71 of the bottom portion 7c and the end face 27a1 of the sleeve portion 27a. The thrust bearing gaps of the first and second thrust bearing portions T1 and T2 are in communication with the seal space S through the radially-extending groove 10c, the circulation groove 10a, and the radially-extending groove 10b.

In the present embodiment, the dynamic pressure generating portion A is formed on the outer circumferential surface of the shaft portion 2a of the shaft member 2 or on the inner circumferential surface of the sleeve portion 27a of the bearing member 27 by performing the printing process using the aforementioned ink-jet printing or the like and the process for hardening the ink. The dynamic pressure generating portions on the thrust bearing surfaces B and C formed on both end faces 2bl and 2b2 of the flange portion 2b can also be formed by performing similar processes, when the forming device shown in FIG. 5 is used.

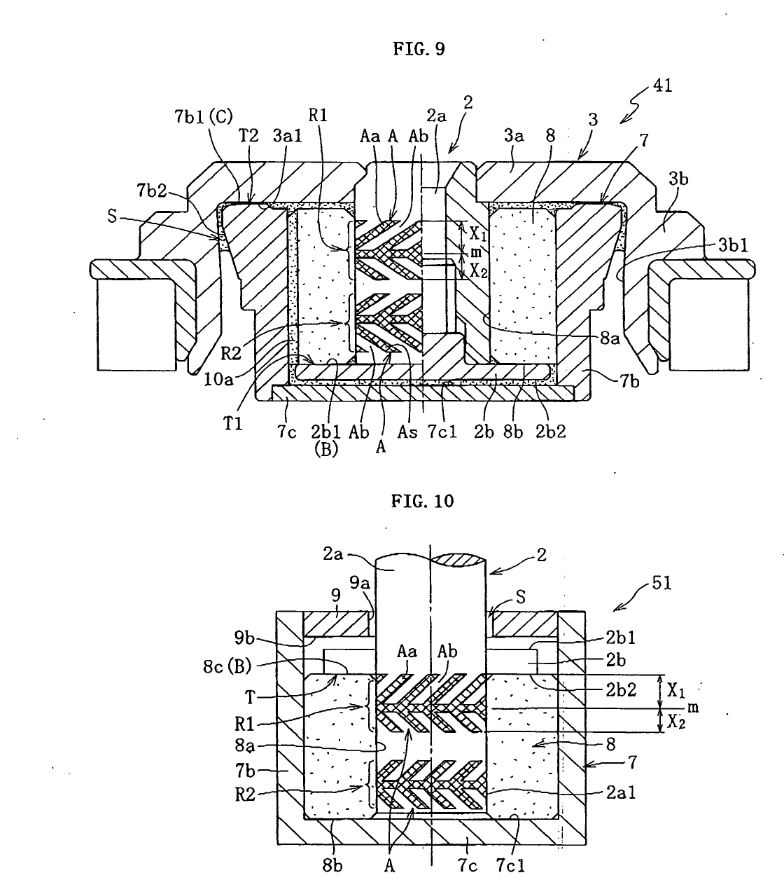

FIG. 9 shows another embodiment of the fluid dynamic bearing device. The fluid dynamic bearing device 41 shown in FIG. 9 is different from the embodiment shown in FIG. 7 mainly in the following points: the seal space S is formed between an upper-end outer circumferential surface 7b2 of the housing 7 and an inner circumferential surface 3b1 of the cylindrical portion 3b of the disc hub 3; and the second thrust bearing portion T2 is formed between an upper end face 7b1 of the housing 7 and a lower end face 3a1 of a plate portion 3a forming the disc hub 3.

In the present embodiment, the second thrust bearing surface C of the second thrust bearing portion T2 is formed on the upper end face 7b1 of the hosing 7. The dynamic pressure generating portion of the second thrust bearing surface C can be formed at formation of the housing 7, when a groove pattern corresponding to the shape of the dynamic pressure generating portion of the second thrust bearing surface C is formed on a mold for forming the housing 7 in advance, for example. In the present embodiment, the dynamic pressure generating portion A is formed on the outer circumferential surface of the shaft portion 2a of the shaft member 2 or the inner circumferential surface of the bearing sleeve 8 by performing the printing process using the aforementioned ink-jet printing or the like and the process for hardening the ink. The dynamic pressure generating portion on each of the thrust bearing surface B formed on the upper end face 2b1 of the flange portion 2b and the thrust bearing surface C formed on the upper end face 7b1 of the housing 7 can be formed in a similar manner.

FIG. 10 shows another embodiment of the fluid dynamic bearing device 1. A thrust bearing portion T of this fluid dynamic bearing device 51 is located on the opening side of the housing 7 and supports the shaft member 2 in a non-contact manner in one of thrust directions with respect to the bearing sleeve 8. The flange portion 2b is provided at an upper level than a lower end of the shaft member 2. The thrust bearing portion T is formed between the lower end face 2b2 of the flange portion 2b and the upper end face 8c of the bearing sleeve 8. The seal member 9 is attached to the inner circumference of the opening of the housing 7, so that the seal space S is formed between the inner circumferential surface 9a of the seal member 9 and an outer circumferential surface 2a1 of the shaft portion 2a of the shaft member 2. A lower end face 9b of the seal member 9 is opposed to the upper end face 2b1 of the flange portion 2b with an axially-extending gap interposed therebetween. When the shaft member 2 is displaced upward, the upper end face 2b1 of the flange portion 2b engages with the lower end face 9b of the seal member 9, thereby retaining the shaft member 2. In the present embodiment, the dynamic pressure generating portion A is formed on the outer circumferential surface of the shaft portion 2a of the shaft member 2 or the inner circumferential surface of the bearing sleeve 8 by performing the printing process using the aforementioned ink-jet printing or the like and the process for hardening the ink. The dynamic pressure generating portion B on the upper end face 8c of the bearing sleeve 8 can also be formed in a similar manner by the printing process and the hardening process described above.

In the above description, a case is described where the dynamic pressure generating grooves in a herringbone pattern or a spiral pattern are used as each of the radial bearing portions R1 and R2 and the thrust bearing portions T1, T2, and T to generate a dynamic pressure action. However, the structure of the dynamic pressure generating portion is not limited thereto. For example, a multiple-lobed bearing, a stepped bearing, a tapered bearing, a tapered and flattened bearing and the like can be used as the radial bearing portions R1 and R2, and a stepped and pocket bearing, a tapered and pocket bearing, a tapered and flattened bearing, a pivot bearing and the like can be used as the thrust bearing portions T1 and T2.

In case of using the multiple-lobed bearing as each of the radial bearing portions R1 and R2, for example, at least one of a radial bearing surface A at the inner circumference of the bearing sleeve 7 and the outer circumferential surface of the shaft member 2 is formed to be a multiple circular-arc surface. A radial baring gap between each circular arc part of that surface and the surface opposed thereto has a wedge-like shape that becomes smaller in the direction of rotation. In this case, the multiple circular-arc surface as the dynamic pressure generating portion can be formed by using the forming device shown in FIG. 1 and performing the ink-jet printing and hardening the ink.

In the above description, a configuration is shown in which the radial bearing portions are provided at two positions in the axial direction, respectively. However, the number of the radial bearing portions is not limited to two. A desired number of the radial bearing portions can be provided. For example, the radial bearing portion can be provided at one location or each of three or more locations in the axial direction.

Moreover, a lubricating oil is shown as an example of the fluid (lubricating fluid) with which the inside of the fluid dynamic bearing device 1 is filled. Other than this, a fluid that can generate a dynamic pressure in each bearing gap, e.g., a magnetic fluid or a gas such as air can be used.

1. A method for forming a dynamic pressure generating portion comprising the steps of: supplying a small amount of an ink onto a surface of a material to print a dynamic pressure generating portion for generating a dynamic pressure of fluid in a bearing gap with an aggregate of the small amount of ink; and hardening the ink.

2. The method for forming a dynamic pressure generating portion according to claim 1, wherein
a printing portion for printing the dynamic pressure generating portion and a hardening portion for hardening the ink are provided at different positions in a circumferential direction and the material, the printing portion, and the hardening portion are relatively rotated to make the printing of the dynamic pressure generating portion and the hardening of the ink proceed in the circumferential direction of the material.

3. The method for forming a dynamic pressure generating portion according to claim 1, wherein the ink has a photocrosslinking property and the hardening of the ink is achieved by radiation of light.

4. A forming device for a dynamic pressure generating portion, the device comprising: an ink supply portion for intermittently supplying a small amount of an ink on a surface of a material; and a light source for emitting light for hardening the ink, wherein the ink supply portion and the light source are arranged to be opposed to the material at different positions in a circumferential direction, and the material, the ink supply portion, and the light source are relatively rotated.

5. A shaft member for a fluid dynamic bearing device, having a dynamic pressure generating portion on an outer circumferential surface thereof, the dynamic pressure generating portion generating a dynamic pressure of fluid, wherein
the dynamic pressure generating portion is formed by supplying a small amount of an ink onto an outer circumferential surface of a shaft-shaped material and hardening an aggregate of the small amount of ink.

6. A fluid dynamic bearing device comprising the shaft member according to claim 5 and a bearing sleeve into which the shaft member is inserted.

7. A bearing sleeve for a fluid dynamic bearing device, having a dynamic pressure generating portion on an inner circumferential surface thereof, the dynamic pressure generating portion generating a dynamic pressure of fluid, wherein
the dynamic pressure generating portion is formed by supplying a small amount of an ink onto an inner circumferential surface of a sleeve-shaped material and hardening an aggregate of the small amount of ink.

8. A fluid dynamic bearing device comprising a shaft member and the bearing sleeve according to claim 7, the shaft member being inserted into the bearing sleeve.

9. A fluid dynamic bearing device comprising: a housing; a bearing sleeve fixed on an inner, circumference of the housing; a shaft member inserted in the bearing sleeve; a radial bearing portion for supporting the shaft member in a radial direction in a non-contact manner; a thrust bearing portion for supporting the shaft member in a thrust direction; and a dynamic pressure generating portion, formed by hardening an aggregate of a small amount of an ink supplied onto a surface of a material of the shaft member, for generating a dynamic pressure of fluid in a bearing gap.

10. The fluid dynamic bearing device according to claim 9, wherein the dynamic pressure generating portion is formed on an outer circumferential surface of the shaft member.

11. The fluid dynamic bearing device according to claim 9, wherein the thrust bearing portion supports the shaft member in the thrust direction in a non-contact manner by a pressure generated in a thrust bearing gap by a dynamic pressure action of the lubricating fluid, and the dynamic pressure generating portion is formed on an end face of the shaft member.

12. A fluid dynamic bearing device comprising: a shaft member; a bearing gap facing the shaft member; an oil with which the bearing gap is filled; and a dynamic pressure generating portion for generating dynamic action of the oil in the bearing gap, wherein
the dynamic pressure generating portion is formed from a resin composition and a solubility parameter of a base resin contained in the resin composition and a solubility parameter of the oil are set in such a manner that an absolute value of a difference between them is 1.0 or more.

13. The fluid dynamic bearing device according to claim 12, wherein the resin composition of the dynamic pressure generating portion is formed by hardening an aggregate of a small amount of an ink.

14. The fluid dynamic bearing device according to claim 12, wherein the resin composition has a photocrosslinking property.

15. The fluid dynamic bearing device according to claim 12, wherein the oil contains at least a diester lubricating oil.

16. A resin composition for forming a dynamic pressure generating portion for generating a dynamic pressure action of oil in a bearing gap, on a surface of a material, wherein
an absolute value of a difference between a solubility parameter of a base resin of the resin composition and a solubility parameter of the oil is 1.0 or more.

17. An oil coming into contact with a surface of a dynamic pressure generating portion that is formed on a surface of a material and generates a dynamic pressure action of the oil in a bearing gap, wherein
an absolute value of a difference between a solubility parameter of the oil and a solubility parameter of a base resin of a resin composition forming the dynamic pressure generating portion is 1.0 or more.

18. A fluid dynamic bearing device comprising: a shaft member; a bearing gap facing the shaft member; and a dynamic pressure generating portion for generating a dynamic pressure action of fluid in the bearing gap, wherein
the dynamic pressure generating portion is formed by hardening an aggregate of a small amount of an ink, and is formed from a thermosetting ink.

19. The fluid dynamic bearing device according to claim 18, wherein the ink further has a photocrosslinking property.

20. A motor comprising: the fluid dynamic bearing device according to claim 6; a rotor magnet; and a stator coil.

21. A method for forming a dynamic pressure generating portion, comprising the step of thermosetting an ink when the dynamic pressure generating portion for generating a dynamic pressure of fluid in a bearing gap is formed with an aggregate of a small amount of an ink.

22. The method for forming a dynamic pressure generating portion according to claim 21, wherein hardening the ink is achieved further by irradiation of light.

23. A motor comprising: the fluid dynamic bearing device according to claim 8; a rotor magnet; and a stator coil.

24. A motor comprising: the fluid dynamic bearing device according to claim 9; a rotor magnet; and a stator coil.

25. A motor comprising: the fluid dynamic bearing device according to claim 12; a rotor magnet; and a stator coil.

26. A motor comprising: the fluid dynamic bearing device according to claim 18; a rotor magnet; and a stator coil.
